(19) United States
(12) Patent Application Publication
(10) Pub. No.: US 2026/0169577 A1
(43) Pub. Date: Jun. 18, 2026

(54) USER INPUT DEVICE WHICH CAN ASSIST DETECTION OF BUTTON TRIGGER

(71) Applicant: PixArt Imaging Inc., Hsin-Chu City (TW)

(72) Inventors: Chih-Ming Sun, Hsin-Chu City (TW); Chung-Yuo Wu, Hsin-Chu City (TW); Chao-Chien Huang, Hsin-Chu City (TW); Bo-Yi Chang, Hsin-Chu City (TW)

(73) Assignee: PixArt Imaging Inc., Hsin-Chu City (TW)

(21) Appl. No.: 19/328,211

(22) Filed: Sep. 14, 2025

Related U.S. Application Data
(60) Provisional application No. 63/734,175, filed on Dec. 15, 2024.

(51) Int. Cl. G06F 3/038; G06F 3/03

(52) U.S. Cl. CPC G06F 3/0383; G06F 3/0308

(57) ABSTRACT

A user input device, comprising: at least one button, configured to provide a control signal to the user input device while being triggered; a first optical sensor, located next to the button, configured to sense first optical data; and a processing circuit, configured to determine a movement direction of an object according to the first optical data, and configured to determine a trigger state of the button according to the movement direction. A user input device which can advance the button trigger time is also disclosed. By this way, the trigger of the button can be detected more quickly, which can assist in determining the combination or the triggering of two or more buttons, thereby increasing the application range of the user's input device.

### CROSS REFERENCE TO RELATED APPLICATIONS

This application claims the benefit of U.S. Provisional Application No. 63/734,175, filed on Dec. 15, 2024. The content of the application is incorporated herein by reference.

### BACKGROUND OF THE INVENTION

### 1. Field of the Invention

The present invention relates to a user input device, and particularly relates to a user input device which can assist detecting the button trigger.

### 2. Description of the Prior Art

A conventional game joystick usually has multiple buttons. When playing games, users can trigger at least one of these buttons (e.g., press or touch the button) to make the game joystick generate a control signal to control the game. Game controls are becoming more and more sophisticated and complex, so the requirements for the delay time between the user's triggering operation and the game joystick generating the control signal are becoming more and more stringent. However, conventional game joysticks usually only start to generate control signals when the user's triggering operation actually occurs, but have no function of detecting in advance which button the user is going to trigger. In such case, not only the delay time for the game joystick to generate a control signal is increased, but also the scope of application of the game joystick is limited.

### SUMMARY OF THE INVENTION

One objective of the present invention is to provide a user input device which can assist detecting the button trigger.

One objective of the present invention is to provide a user input device which can advance the button trigger time.

One embodiment of the present invention discloses a user input device, comprising: at least one button, configured to provide a control signal to the user input device while being triggered; a first optical sensor, located next to the button, configured to sense first optical data; and a processing circuit, configured to determine a movement direction of an object according to the first optical data, and configured to determine a trigger state of the button according to the movement direction.

Another embodiment of the present invention discloses a user input device, comprising: a plurality of buttons, comprising a first button and a second button, configured to provide a control signal to the user input device while being triggered; a first optical sensor, located next to the first button and the second button, configured to sense first optical data; and a processing circuit, configured to determine which one of the buttons the object is to move from the first button to according to the first optical data, and if it is determined that the object is to move to the second button, the triggering time of the second button is advanced.

Still another embodiment of the present invention discloses a user input device, comprising: a plurality of buttons, comprising a first button, a second button and a third button, configured to provide a control signal to the user input device while being pressed; a first optical sensor, surrounded by the first button, the second button and the third button, configured to sense first optical data; and a processing circuit, configured to determine a control signal representing permutations of button actuations involving at least two of the first button, the second button, and the third button according to the first optical data., with repetition allowed and without actual physical presses of the buttons.

In view of above-mentioned embodiments, the trigger of the button can be detected more quickly, which can assist in determining the combination or the triggering of two or more buttons, thereby increasing the application range of the user's input device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a joystick according to one embodiment of the present invention.

FIG. 2 is a schematic diagram illustrating a cross-sectional view of the joystick illustrated in FIG. 1 of the present invention.

FIG. 3 is a schematic diagram illustrating movements of the finger, according to one embodiment of the present invention.

FIG. 4 is a schematic diagram illustrating different FOVs (field of view) of the first optical sensor, according to one embodiment of the present invention.

FIG. 5 is a schematic diagram illustrating that the trigger time of the button is advanced, according to one embodiment of the present invention.

FIG. 6, FIG. 7A and FIG. 7B are schematic diagrams illustrating the buttons is to be triggered and the object is leaving the button, according to embodiments of the present invention.

FIG. 8 is a schematic diagram illustrating a joystick according to another embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices. Please note, in following embodiments, a joystick, which can be used to play a game, is used as an example for explaining. However, the concept disclosed by the present application can be used to any other user input device with at least one button or at least one key, such as a mouse or a keyboard. Further, in following embodiments, “a button is triggered” means the button is touched, pressed or being hovered.

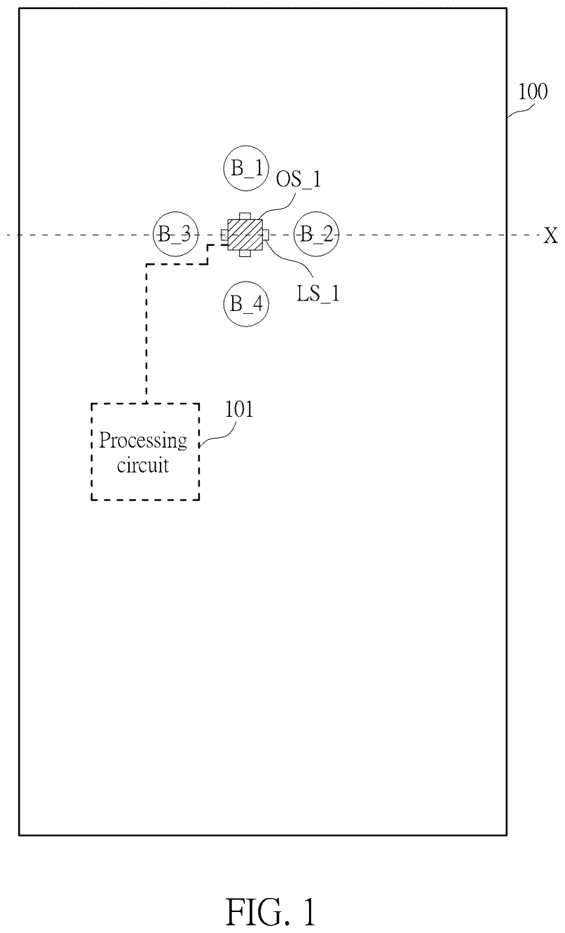

FIG. 1 is a schematic diagram illustrating a joystick 100 according to one embodiment of the present invention. Please note the scope of the present invention is not limited to the positions, the numbers, and the shapes of components shown in FIG. 1 and in following embodiments. The joystick 100 comprises at least one button, a first optical sensor OS_1 and a processing circuit 101. The button is configured to provide a control signal to the joystick 100 while being triggered. As above-mentioned, the button can be trigged by various kinds of operations (e.g., press, touch or hovering). In the embodiment of FIG. 1, four buttons B_1, B_2, B_3 and B_4 are used as an example for explaining.

The first optical sensor OS_1 is located next to each of the buttons B_1, B_2, B_3 and B_4, and is configured to sense first optical data. In one embodiment, the first optical sensor OS_1 is an image sensor, thus the first optical data is at least one image. In the embodiment of FIG. 1, the buttons B_1, B_2, B_3 and B_4 are arranged to form a polygon, and the first optical sensor OS_1 is in a middle portion of the polygon and surrounded by the buttons B_1, B_2, B_3 and B_4. Also, in one embodiment, no optical sensor is provided on any one of the buttons B_1, B_2, B_3 and B_4. In one embodiment, the joystick 100 further comprises at least one light source located in the middle portion. Only one light source LS_1 is labeled in the embodiment of FIG. 1 for explaining.

The processing circuit 101 is configured to determine a movement direction of an object according to the first optical data, and configured to determine a trigger state of the button according to the movement direction. In following embodiments, a finger F is used as an example of the object to explain the concept of the present invention.

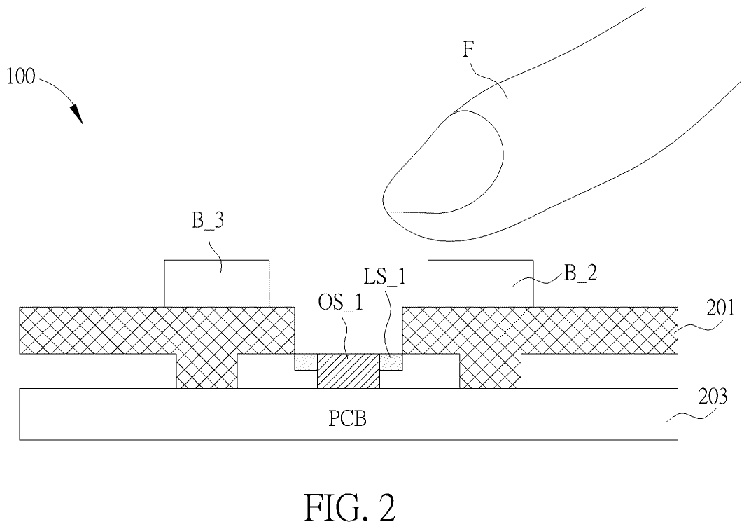

FIG. 2 is a schematic diagram illustrating a cross-sectional view of the joystick 100 illustrated in FIG. 1 of the present invention. Specifically, FIG. 2 is a cross-sectional view along the dotted line X in FIG. 1. In the embodiment of FIG. 2, the joystick 100 comprises a case 201 and a printed circuit board 203 provided inside the case 201. The buttons B_2 and B_3 are provided outside the case 201. Further, the first optical sensor OS_1 and the light source LS_1 are provided between the buttons B_2, B_3 and inside the case 201. By this way, when the finger F is moving between the buttons B_1, B_2, B_3 and B_4 and above the first optical sensor OS_1, the light emitted from the light source LS_1 can emit the finger F, and the images of the finger F can be sensed by the first optical sensor OS_1.

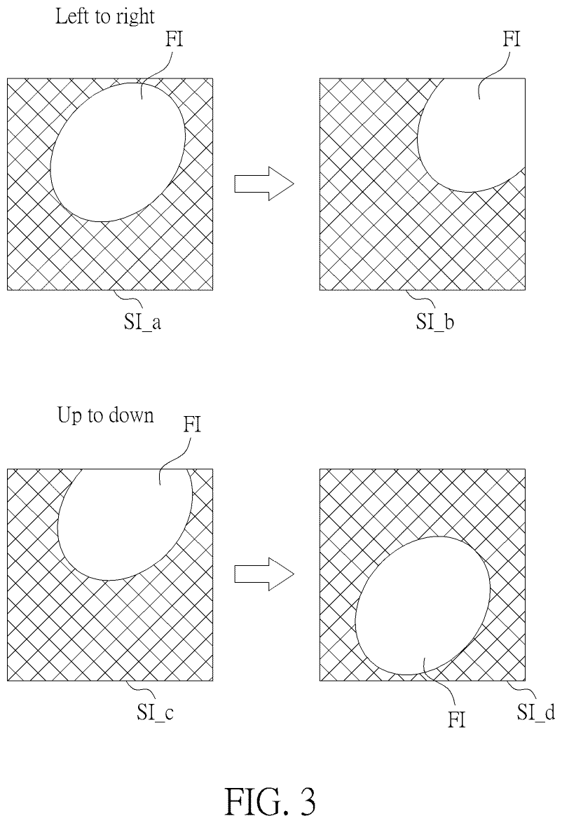

As above-mentioned, the processing circuit 101 may determine a movement direction of an object according to the first optical data. FIG. 3 is a schematic diagram illustrating movements of the finger F, according to one embodiment of the present invention. In the embodiment of FIG. 3, the sensing image SI means the image sensed by the first optical sensor OS_1. Based on the structures show in FIG. 1 and FIG. 2, a finger image FI can also be sensed by the first optical sensor OS_1 when the finger F is moved between the buttons B_1, B_2, B_3 and B_4. As stated in the embodiments of FIG. 1 and FIG. 2, the finger F may reflect the light from the light source LS_1. Accordingly, finger images FI with higher brightness may appear in the sensing image SI.

Accordingly, the movement direction of the finger F can be determined according to the finger images FI in different sensing images SI. As shown in FIG. 3, in the upper diagram, the finger F is determined to move from left to right since the finger image FI in the sensing images SI_a and SI_b moves from left to right. Further, in the lower diagram of FIG. 3, the finger F is determined to move from up to down since the finger image FI in the sensing images SI_c and SI_d moves from up to down. Please note, the movement direction of the finger F and the movement direction of the finger image FI are not limited to be the same. The movement direction of the finger F and the movement direction of the finger image FI may be different or even be opposite due to the arrangement or the algorithm used by the first optical sensor OS_1. In following embodiments, an example that the movement direction of the finger F and the movement direction of the finger image FI are the same is provided for explaining.

In one embodiment, the first optical sensor OS_1 is an event sensor and the first optical data is an event signal, wherein the event signal corresponding to event variation (e.g., brightness variation of pixel images). The processing circuit 101 can determine the position of the event according to the event signals, to determine a movement direction of the finger F. For example, each pixel of the first optical sensor OS_1 has its own event signal. Accordingly, the processing circuit 101 may determine which pixel image of the sensing image SI has variation (e.g., brightness change), and then determine the movement direction of the finger F according to the pixel image variations.

As above-mentioned, the processing circuit 101 may determine a trigger state of the button according to the movement direction of the finger F. In one embodiment, the trigger state is a trigger sequence of the buttons. For example, in the embodiment of FIG. 1, if the button B_1 is already triggered, and the move direction of the finger F is up to down. The trigger sequence of the buttons is determined to be the button B_1→the button B_4. In another example, if the finger image appears on the right first and then moves to the upper left and then to the lower left, the trigger sequence of the buttons is determined to be the button B_2→the button B_1→the button B_3. Please note, the determination of the trigger sequence is not limited that a button needs to be triggered first. The determination of the trigger sequence can be determined according to the finger image FI without a button being triggered first.

In more detail, the trigger sequence is determined based on the finger images FI to more quickly detect the trigger of the button, so two or more button operations can be connected together, making the joystick more widely used. For example, when the user is playing a game and quickly triggers buttons B_1-B_2 (for example, a time interval of 0.1 ms), it is determined to trigger a combo skill or a combination skill in the game. In this case, if the user moves too slowly from the button B_1 to the button B_2 (for example, a time interval of 0.2 ms), the triggering of the combo skill or the combination skill may fail. If the method disclosed in the present invention is used, when the user's finger leaves the button B_1, before the button B_2 is triggered, it can be detected that the finger is about to trigger the button B_2 (at this time, the interval is 0.1 ms), and the button B_2 can be directly triggered even if the button B_2 does not receive the triggering operation provided by the user yet (e.g., a touch, a pressing or a hovering). Therefore, the time interval between triggering of buttons B_1 and B_2 is 0.1 ms instead of 0.2 ms, and the combo skill or the combination skill can be successfully triggered.

The sensitivity of connecting button operations may be set by various methods. For example, the sensitivity may be adjusted by the user, depending whether the user needs such function or not. For another example, the game console may automatically set the sensitivity according to the type of the game which the user is playing. Please note, the above-mentioned detection of the trigger of the button may also be regarded as “prediction”, since the button is not triggered yet.

However, in another embodiment, the detection of the trigger of the button is performed based on permutations of button actuations involving at least two buttons. For example, in the embodiment of FIG. 1, a finger moves over buttons B1-B2-B4-B2 in sequence. Even if none of these buttons are pressed, the finger movement can still be determined based on the first optical data sensed by the first optical sensor OS_1. The processing circuit 101 can then generate control signals corresponding to the sequential pressing of buttons B1-B2-B4-B2 based on the finger movement. As previously described, these control signals can be individual signals corresponding to the sequential pressing of buttons B1-B2-B4-B2, or at least one combination signal corresponding to the sequential pressing of buttons B1-B2-B4-B2.

A joystick based on such embodiment can be regarded as: A joystick, comprising a plurality of buttons, a first optical sensor and a processing circuit. The buttons comprise a first button (e.g., button B_1 in FIG. 1), a second button (e.g., button B_2) and a third button (e.g., button B_4), configured to provide a control signal to the user input device while being pressed. The first optical sensor (e.g., the first optical sensor OS_1 in FIG. 1) is surrounded by the first button, the second button and the third button, configured to sense first optical data. The processing circuit (e.g., the processing circuit 101) is configured to determine a control signal representing permutations of button actuations involving at least two of the first button, the second button, and the third button (e.g., B_2→B_4, or B_1→B_2→B_4) according to the first optical data., with repetition allowed (e.g., B_1→B_2→B_1) and without actual physical presses (e.g., pressed by a finger) of the buttons.

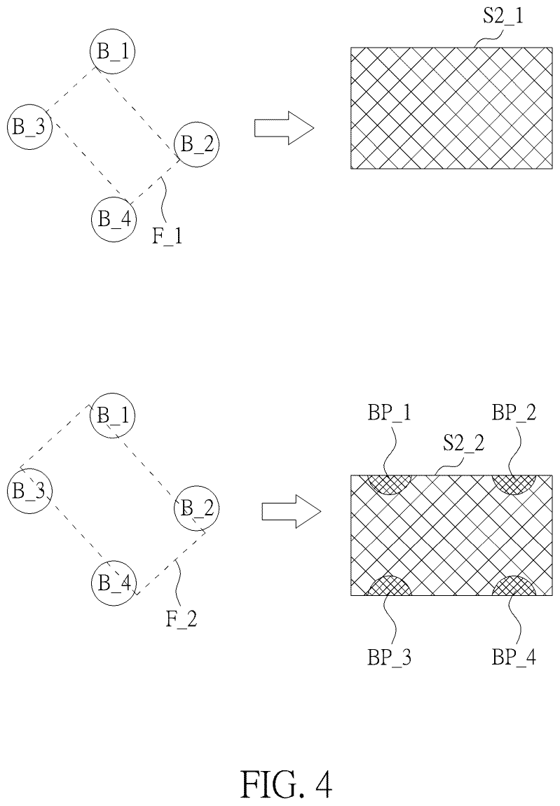

The contents in the sensing image SI may be different corresponding to the FOVs (field of view) of the first optical sensor OS_1. FIG. 4 is a schematic diagram illustrating different FOVs (field of view) of the first optical sensor, according to one embodiment of the present invention. As shown in FIG. 4, in the upper diagram, the FOV F_1 is smaller, thus the first optical sensor OS_1 does not sense images of the buttons B_1-B_4. On the contrary, in the lower button of the FIG. 4, the FOV F_2 is larger, thus the first optical sensor OS_1 sense images of a portion of each of the buttons B_1-B_4.

Specifically, in the upper diagram of FIG. 4, the sensing image SI_1 does not comprise any image of button. In the lower diagram of FIG. 4, the sensing image SI_2 comprises button portion images BP_1, BP_2, BP_3 and BP_4 respectively of each of the buttons B_1-B_4. Please note, the positions of the button portion images may be different corresponding to the position or the arrangement of the first optical sensor OS_1. The button portion images in FIG. 4 can be used as references to assist the movement direction determination of the finger F, to make the determination more precise. The above-mentioned event signal generated by the event sensor may also be affected by different FOVs. For example, if button portion images BP_1, BP_2, BP_3 and BP_4 are sensed, corresponding event signals may have constant values since the buttons B_1-B_4 do not move thus cause no brightness variation (i.e., no event variation).

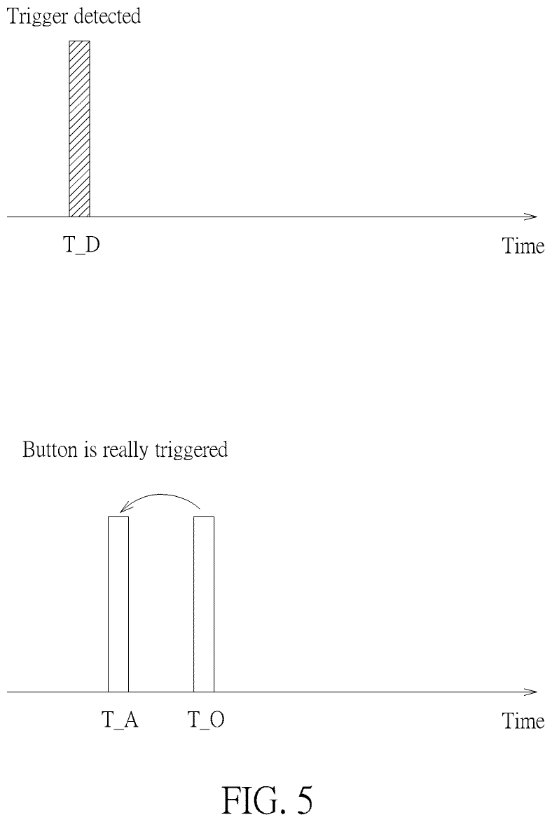

As above-mentioned, the trigger of the button may be advanced according to the movement direction of the finger F. FIG. 5 is a schematic diagram illustrating that the trigger time of the button is advanced, according to one embodiment of the present invention. In FIG. 5, the time T_D represents that a trigger of a button is detected. Also, the time T_O represents an original trigger time of the button. For more detail, the time T_O represents a time that the button really receives the trigger operation (e.g. been pressed). In other words, the time T_O represents a trigger time of a conventional button. In the embodiment of FIG. 5, the time T_O is advanced to the time T_A according to the detected movement direction of the finger F, as described in the above-mentioned embodiments. The time T_A is not before the time T_D, since the time T_O is advanced depending on the event occurred at the time T_D.

Based upon the embodiment illustrated in FIG. 5, the operations of the joystick 100 may be described as follows: A joystick, comprising a plurality of buttons, a first optical sensor and a processing circuit. The buttons comprises a first button (e.g., B_1) and a second button (e.g., B_2), configured to provide a control signal to the user input device while being triggered. The first optical sensor (e.g., OS_1) is located next to the first button and the second button, and is configured to sense first optical data. The processing circuit (e.g., 101) is configured to determine which one of the buttons the finger is to move from the first button to according to the first optical data, for example, determine which one of the buttons B_2, B_3 and B_4 the finger F is mover from the button B_1 to. If it is determined that the finger is to move to the second button, the trigger time of the second button is advanced, as described in the embodiment of FIG. 5. The trigger time of the second button is advanced to a first time (e.g., time T_A) which is not before a second time (e.g., T_D) at which the processing circuit determines that the finger is to move to the second button.

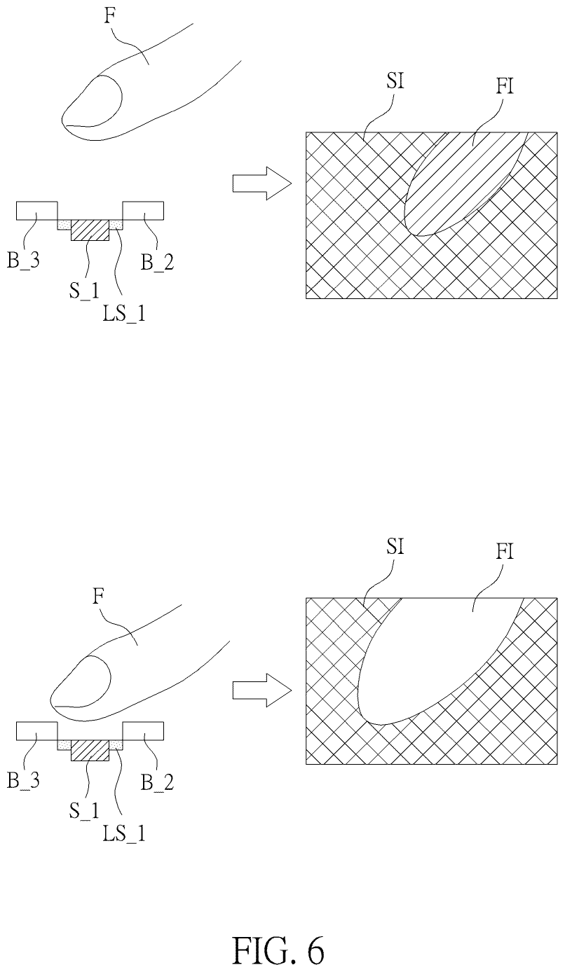

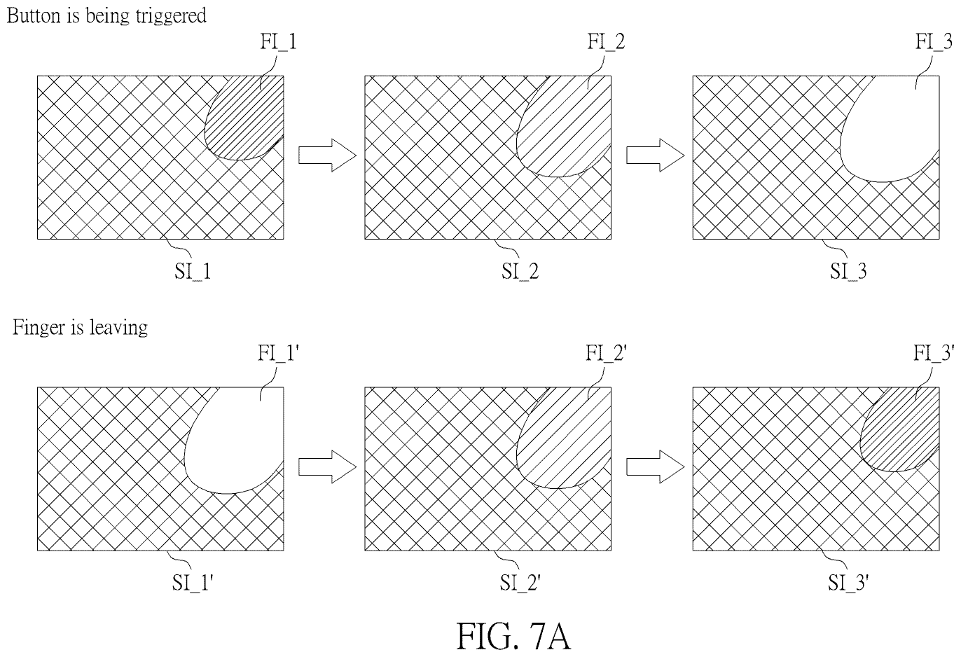

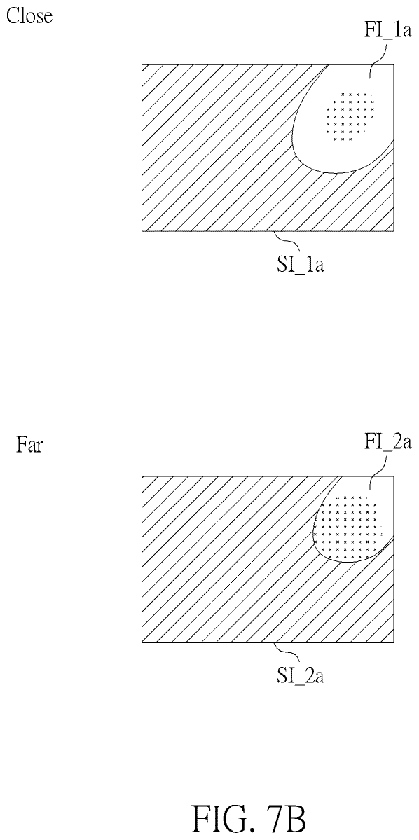

In one embodiment, the processing circuit 101 determines a trigger state according to brightness variation of continuous images sensed by the first optical sensor, wherein the trigger state indicates which one of the buttons is to be triggered. FIG. 6, FIG. 7A and FIG. 7B are schematic diagrams illustrating the buttons is to be triggered and the finger is leaving the button, according to embodiments of the present invention. Please note, in the embodiment of FIG. 6, only some components in the joystick 100 of FIG. 1 are illustrated, for the convenience of explaining.

In the embodiment of FIG. 6, the light source LS_1 may emit light to the finger F, thus the first optical sensor OS_1 may receive the reflected light from the finger F. In the upper diagram of FIG. 6, the finger F is farer from the first optical sensor OS_1, the light source LS_1 and the buttons B_2, B_3, thus the first optical sensor OS_1 receives less reflected light or no reflected light from the finger F. Accordingly, in such case, the finger image FI in the corresponding sensing image SI has a lower brightness which is represented by oblique lines. Oppositely, in the lower diagram of FIG. 6, the finger F is closer the first optical sensor OS_1, the light source LS_1 and the buttons B_2, B_3, thus the first optical sensor OS_1 receives more reflected light from the finger F. Accordingly, in such case, the finger image FI in the corresponding sensing image SI has a higher brightness which is represented by blank space.

The trigger state of the finger F may be determined based on the rule stated in FIG. 6. In the upper diagram of FIG. 7A, the trigger state indicates which one of the buttons is triggered, which means the finger F is approaching the button. The processing circuit 101 determines such trigger state according to brightness variation of continuous images or event signals sensed by the first optical sensor OS_1. More specifically, if the finger F in FIG. 7A is approaching the button, the finger image FI is becoming larger and reflected light from the finger F received by the first optical sensor OS_1 is increasing. Accordingly, in the upper diagram of FIG. 7A, the size sequence of the finger images FI_1, FI_2 and FI_3 is FI_1<FI_2<FI_3, and the brightness sequence of the finger images FI_1, FI_2 and FI_3 is FI_1<FI_2<FI_3.

In the lower diagram of FIG. 7A, the trigger state indicates which one of button the finger F is leaving, and the processing circuit 101 determines such trigger state according to brightness variation of continuous images sensed by the first optical sensor OS_1. More specifically, if the finger F in FIG. 7A is leaving the button, the finger image FI is becoming smaller and reflected light from the finger F received by the first optical sensor OS_1 is decreasing. Accordingly, in the lower diagram of FIG. 7A, the size sequence of the finger images FI_1′, FI_2′ and FI_3′ is FI_1′>FI_2′>FI_3′, and the brightness sequence of the finger images FI_1′, FI_2′ and FI_3′ is FI_1′>FI_2′>FI_3′.

Please note, the “continuous images” mentioned in the embodiments of FIG. 7A may mean direct continuous images or in-direct images. For example, if the first optical sensor senses N sensing images, the sensing images SI_1, SI_2 and SI_3 in FIG. 7A may respectively mean image(N-2), image (N-1), and image N, or mean image(N-4), image (N-2), and image N. In other words, in one embodiment, no sensing image is generated between any two of the sensing images SI_1, SI_2 and SI_3. In another embodiment, at least one sensing image may exist between any two of the sensing images SI_1, SI_2 and SI_3. Such rule can also be applied to the sensing images SI_1′, SI_2′ and SI_3′ in FIG. 7A.

In the embodiments of FIG. 6 and FIG. 7A, the positions of the finger F can also be acquired based on the brightness variation. Accordingly, the button which is to be triggered or from which the finger F is leaving can be determined based on the position of the finger F. Additionally, the sensing image with no button image can be used to implement the embodiments illustrated in FIG. 6 and FIG. 7A, such as the sensing image SI_1 shown in FIG. 4. Besides, the sensing image with at least portion button image can be used to implement the embodiments illustrated in FIG. 6 and FIG. 7A as well, such as the sensing image SI_2 shown in FIG. 4.

In the embodiment of FIG. 7A, the first optical sensor OS_1 is an image sensor. However, in the embodiment of FIG. 7B, the first optical sensor OS_1 is the above-mentioned event sensor. As stated above, the event signal corresponds to event variation such as brightness variation of pixel images. Therefore, in the embodiment of FIG. 7B, the event signal is assumed as 1 if the brightness variation is over a variation threshold and is assumed as 0 if the brightness variation is below the variation threshold.

Further, in the embodiment of FIG. 7B, the image pixels with symbols “x” in the finger images FI_1a and FI_2a mean the image pixels corresponding to the event signal 1. In other words, the image pixels with symbols “x” in the finger images FI_1 and FI_2 mean the image pixels which have brightness variations over the variation threshold.

In the upper diagram of FIG. 7B, the finger is closer to the light source LS_1 and the first optical sensor OS_1. Accordingly, in this state, light is concentrated in a specific region of the finger (such as the middle area). Therefore, when the finger moves in this state, the distribution of image pixels with large brightness variations will also be more concentrated. In the lower diagram of FIG. 7B, the finger is farther away from the light source LS_1 and the first optical sensor OS_1. In this state, light is irradiated on a more dispersed region of the finger. Therefore, when the finger moves in this state, the distribution of image pixels with large brightness changes will also be more dispersed. Accordingly, based on the example shown in FIG. 7B, the distance between the finger and the buttons can be determined based on a distribution of a region having the event signal 1 in the finger image. Thereby the approaching or leaving of the finger can be determined according to distances determined based on the event signal. However, FIG. 7B is only an example for explaining and does not mean to limit the event signal distributions of the present invention.

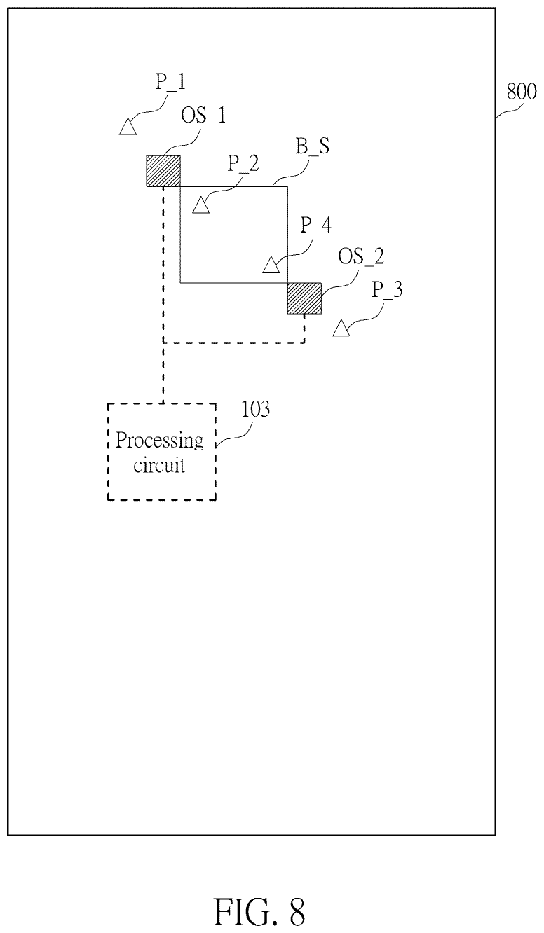

In the above-mentioned embodiments, only one optical sensor (the first optical sensor) is used to determine the movement of the finger F. However, more than one optical sensor can be used to determine the movement of the finger F. FIG. 8 is a schematic diagram illustrating a joystick according to another embodiment of the present invention. As shown in FIG. 8, the joystick 800 comprises a single button B_S, a first optical sensor OS_1 and a second optical sensor OS_2. The first optical sensor OS_1 and the second optical sensor OS_2 are respectively next to different portions of the single button B_S. In such case, the above-mentioned trigger state indicates a direction from which the finger F triggers the single button.

For example, if the finger F moves from the position P_1 to P_2, the sensing image of the first optical sensor OS_1 can be used to determine that the single button B_S is triggered from the upper left to the lower right. On the contrary, if the finger F moves from position P_3 to P_4, the sensing image of the second optical sensor OS_2 can be used to determine that the single button B_S is triggered from the lower right to the upper left. The embodiment illustrated in FIG. 1 and the embodiment illustrated in FIG. 8 can be independently used or be combined. By this way, the joystick can have a wider range of applications.

In view of above-mentioned embodiments, the trigger of the button can be detected more quickly, which can assist in determining the combination or the triggering of two or more buttons, thereby increasing the application range of the user's input device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A user input device, comprising:
at least one button, configured to provide a control signal to the user input device while being triggered;
a first optical sensor, located next to the button, configured to sense first optical data; and
a processing circuit, configured to determine a movement direction of an object according to the first optical data, and configured to determine a trigger state of the button according to the movement direction.

2. The user input device of claim 1, wherein no optical sensor is provided on any one of the button.

3. The user input device of claim 1, comprising a plurality of buttons, wherein the trigger state is a trigger sequence of the buttons.

4. The user input device of claim 3, wherein the buttons are arranged to form a polygon, with the first optical sensor is in a middle portion of the polygon.

5. The user input device of claim 4, further comprising:
at least one light source, located in the middle portion.

6. The user input device of claim 1, comprising a single button and a second optical sensor, wherein the first optical sensor and the second optical sensor are respectively next to different portions of the single button, wherein the trigger state indicates a direction from which the object triggers the single button.

7. The user input device of claim 1, wherein the first optical sensor is an image sensor, and the first optical data comprises images of a portion of each of the buttons.

8. The user input device of claim 7, wherein the trigger state indicates which one of the buttons is to be triggered, wherein the processing circuit determines the trigger state according to brightness variation of continuous images sensed by the first optical sensor.

9. The user input device of claim 1, wherein the first optical sensor is an event sensor, wherein the trigger state indicates which one of the button the object is leaving, wherein the processing circuit determines the trigger state according to a distribution of a region which corresponds to an event signal with a specific value in a finger image sensed by the first optical sensor.

10. A user input device, comprising:
a plurality of buttons, comprising a first button and a second button, configured to provide a control signal to the user input device while being triggered;
a first optical sensor, located next to the first button and the second button, configured to sense first optical data; and
a processing circuit, configured to determine which one of the buttons the object is to move from the first button to according to the first optical data, and if it is determined that the object is to move to the second button, the triggering time of the second button is advanced.

11. The user input device of claim 10, the trigger time of the second button is advanced to a first time which is not before a second time at which the processing circuit determines that the object is to move to the second button.

12. The user input device of claim 10, wherein no optical sensor is provided on the buttons.

13. The user input device of claim 12, wherein the buttons are arranged to form a polygon, with the first optical sensor is in a middle portion of the polygon.

14. The user input device of claim 13, further comprising:
at least one light source, located in the middle portion.

15. The user input device of claim 10, comprising a single button and a second optical sensor, wherein the first optical sensor and the second optical sensor are respectively next to different portions of the single button, wherein the trigger state indicates a direction from which the object triggers the single button.

16. The user input device of claim 10, wherein the first optical sensor is an image sensor, and the first optical data comprises images of a portion of each of the buttons.

17. The user input device of claim 16, wherein the processing circuit determines a trigger state according to brightness variation of continuous images sensed by the first optical sensor, wherein the trigger state indicates which one of the buttons is to be triggered.

18. The user input device of claim 10, wherein the first optical sensor is an event sensor, wherein the processing circuit determines a trigger state according to a distribution of a region which corresponds to an event signal with a specific value in a finger image sensed by the first optical sensor, wherein the trigger state indicates which one of the buttons the object is leaving.

19. A user input device, comprising:
a plurality of buttons, comprising a first button, a second button and a third button, configured to provide a control signal to the user input device while being pressed;
a first optical sensor, surrounded by the first button, the second button and the third button, configured to sense first optical data; and
a processing circuit, configured to determine a control signal representing permutations of button actuations involving at least two of the first button, the second button, and the third button according to the first optical data, with repetition allowed and without actual physical presses of the buttons.
